(19) United States
(12) Patent Application Publication
(10) Pub. No.: US 2022/0319081 A1
(43) Pub. Date: Oct. 6, 2022

(54) DISPLAY CONTROL METHOD AND DISPLAY SYSTEM

(71) Applicant: SEIKO EPSON CORPORATION, Tokyo (JP)

(72) Inventors: Kota TAKEUCHI, Matsumoto-shi (JP); Hiroyuki ICHIEDA, Matsumoto-shi (JP); Kentaro IDE, Shiojiri-shi (JP); Kenichiro TOMITA, Matsumoto-shi (JP); Tetsuya ASANO, London (GB)

(73) Assignee: SEIKO EPSON CORPORATION, Tokyo (JP)

(21) Appl. No.: 17/707,397

(22) Filed: Mar. 29, 2022

(30) Foreign Application Priority Data
Mar. 30, 2021 (JP) 2021-056788

(51) Int. Cl. G06T 11/60; G06T 3/40; G06F 3/14

(52) U.S. Cl. CPC G06T 11/60; G06T 3/40; G06F 3/14; G06T 2200/24

(57) ABSTRACT

A display control method includes receiving, by a first terminal device, operation for selecting a first terminal mode, which is a mode used by the first terminal device, among a plurality of modes designating a range of an image, outputting, by the first terminal device, a first image, which is an image in a first range, designated by the first terminal mode among images generated by the first terminal device, receiving, by a second terminal device, operation for selecting a second terminal mode, which is a mode used by the second terminal device, among the plurality of modes, outputting, by the second terminal device, a second image, which is an image in a second range, designated by the second terminal mode among images generated by the second terminal device, and displaying, by a display device, an image in which the first image and second image are side by side.

The present application is based on, and claims priority from JP Application Serial Number 2021-056738, filed Mar. 30, 2021, the disclosure of which is hereby incorporated by reference herein in its entirety.

### BACKGROUND

### 1. Technical Field

The present disclosure relates to a display control method and a display system.

### 2. Related Art

There has been known a device that divides a screen and displays images supplied from a plurality of terminal devices.

For example, JP-A-2010-276824 (Patent Literature 1) discloses an image display system including a plurality of image supply devices that supply images and an image display device capable of displaying, in one or a plurality of screen regions, the images supplied from the plurality of image supply devices.

The image supply devices respectively display an image for common screen operation on which display states of the images displayed by the image display device can be operated The image for common screen operation includes a layout image having divided layout frames indicating the configurations of the one or the plurality of screen regions. The divided layout frames can foe changed by operation on the image for common screen operation of a user.

However, when the divided layout frames displayed on the image for common screen operation is changed and the number of divisions and sizes of the screen regions in which the image display device displays the images are changed, a changeable number of divisions and the sizes of the screen regions are fixed. Therefore, there has been room of improvement in operability of a layout.

### SUMMARY

An aspect of the present disclosure is directed to a display control method including: a first terminal device receiving operation for selecting a first terminal mode, which is a mode used by the first terminal device, among a plurality of modes for designating a range of an image; the first terminal device outputting a first image, which is an image in a first range, designated by the first terminal mode among images generated by the first terminal device; a second terminal device receiving operation for selecting a second terminal mode, which is a mode used by the second terminal device, among the plurality of modes; the second terminal device outputting a second image, which is an image in a second range, designated by the second terminal mode among images generated by the second terminal device; and a display device displaying an image in which the first image and the second image are arranged side by side.

Another aspect of the present disclosure is directed to a display system including a first terminal device, a second terminal device, and a display device. The first terminal device includes at least one first processor that executes: receiving operation for selecting a first terminal mode, which is a mode used by the first terminal device, among a plurality of modes for designating a range of an image; and outputting a first image, which is an image in a first range, designated by the first terminal mode among images generated by the first terminal device, a second terminal device includes at least one second processor that executes: receiving operation for selecting a second terminal mode, which is a mode used by the second terminal device, among the plurality of modes; and outputting a second image, which is an image in a second range, designated by the second terminal mode among images generated by the second terminal device, and the display device includes an optical device that displays an image in which the first image and the second image are arranged side by side.

### BRIEF DESCRIPTION OF THE DRAWINGS

FIG. 1 is a diagram showing an example of a system configuration.

FIG. 2 is a diagram showing the configuration of a terminal device.

FIG.3 is a diagram showing the configuration of a host device.

FIG. 4 is a diagram showing an application image.

FIG. 5 is a diagram showing the application image.

FIG. 6 is a diagram showing the application image.

FIG. 7 is a diagram showing the application image.

FIG. 8 is a diagram showing an example of an interface image.

FIG. 9 is a diagram showing a setting example of a capture range.

FIG. 10 is a diagram showing a setting example of the capture range.

FIG. 11 is a diagram showing a setting example of the capture range.

FIG. 12 is a diagram showing a setting example of the capture range.

FIG. 13 a diagram showing an image for projection displayed on a projection surface.

FIG. 14 is a diagram showing the image for projection displayed on the projection surface.

FIG. 15 is a diagram showing the image for projection displayed on the projection surface.

FIG. 16 is a diagram showing the image for projection displayed on the projection surface.

FIG. 17 is a flowchart showing the operation of the terminal device.

FIG. 18 is a flowchart showing the operation of the terminal device.

FIG. 19 is a flowchart showing the operation of the terminal device.

FIG. 20 is a flowchart showing the operation of the host device.

### DESCRIPTION OF EXEMPLARY EMBODIMENTS

### 1. System Configuration

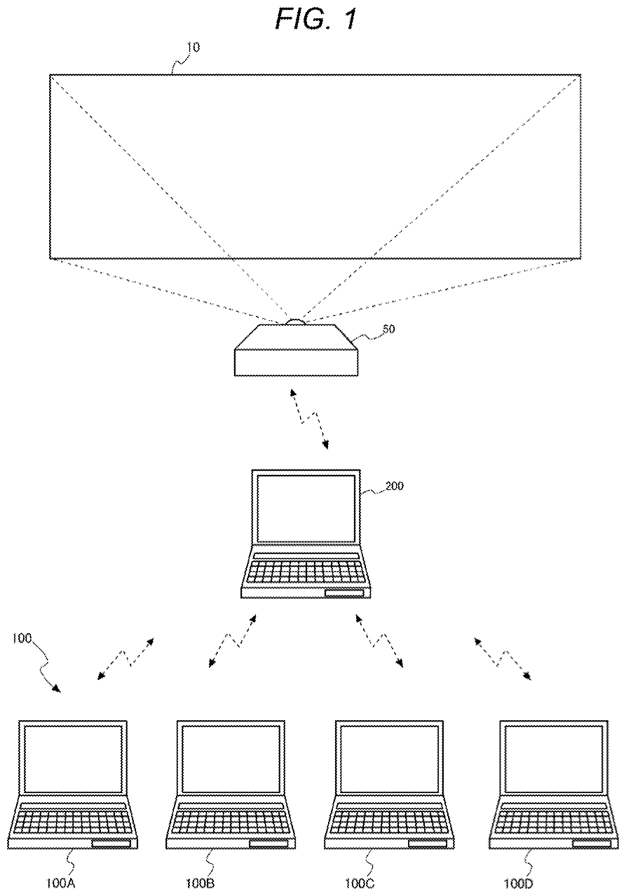

FIG. 1 is a diagram showing an example of a system configuration of a display system.

A display system in the embodiment shown in FIG. 1 includes a projector 50, a plurality of terminal devices 100, and a host device 200.

An image for projection 15 is supplied to the projector 50 from the host device 200 wirelessly connected to the projector 50. The projector 50 is equivalent to a display device. The projector 50 includes optical devices such as a light source, a light modulation device such as a liquid crystal panel, and a lens, generates image light based on the supplied image for projection 15, and enlarges and projects the generated image light onto a projection surface 10. Consequently, the image for projection 15 is displayed on the projection surface 10. The display device may be a direct view-type display including optical devices such as a display panel and a light source.

One projector 50 is used in the display system shewn in FIG. 1. However, it is also passible to perform tiling projection for displaying an image on the projection surface 10 using a plurality of projectors 50. The coupling of the projector 50 and the host device 200 may be wireless or may be wired.

The terminal, devices 100 and the host device 200 are information processing devices including communication devices. As the terminal devices 100 and the host device 200, for example, a notebook PC (Personal Computer), a desktop PC, a table terminal, a smartphone, or a PDA (Personal Digital Assistant) is used.

The terminal devices 100 are wirelessly connected to the host device 200 and transmit capture images 55 explained below to the host device 200. In FIG. 1, four terminal devices 100A, 100B, 100C, and 100D are shown as the plurality of terminal devices 100. However, the number of terminal devices 100 is not limited to four. In FIG. 1, a configuration in which the terminal devices 100 and the host device 200 are wirelessly connected is shown. However, the coupling of the terminal devices 100 and the host device 200 may be wired.

The terminal device 100A is equivalent to a first terminal device, the terminal device 100B is equivalent to a second terminal device, the terminal device 100C is equivalent to a third terminal device, and the terminal device 100D is equivalent to a fourth terminal device.

The host device 200 generates the image for projection 15, which is an image that the host device 200 causes the projector 50 to project, based on the capture images 55 received from the terminal devices 100. The host device 200 arranges the capture images 55 received from the plurality of terminal devices 100 and generates the image for projection 15, which is an image to be displayed on the projection surface 10. The host device 200 outputs the generated image for projection 15 to the projector 50.

### 2. Configuration of the Terminal Device

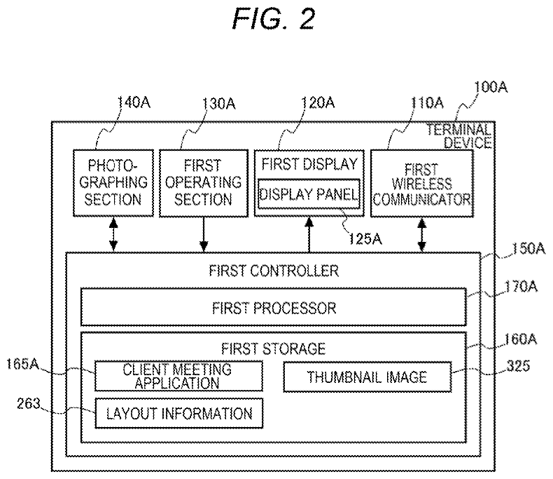

FIG. 2 is a block diagram showing the configuration of the terminal device 100.

The terminal device 100A, the terminal device 100B, the terminal device 100C, and the terminal device 100D include substantially the same configuration. Therefore, the configuration of the terminal device 100A is explained as an example. In the following explanation, when it is unnecessary to distinguish the terminal devices 100A, 100B, 100C, and 100D, the terminal devices 100A, 100B, 100C, and 100D are sometimes referred to as terminal devices 100. Components relating to the terminal device 100A are denoted by signs with A. Components relating to the terminal device 100B are denoted by signs with B. The same applies to the terminal device 100C and the terminal device 100D. When a larger number cf terminal devices 100 are explained, for specific terminal devices 100 and components relating to the specific terminal devices 100 as well, the same and specific alphabets are added to the ends of signs for explanation. For the components relating to the terminal devices 100 as well, when it is unnecessary to distinguish the components, the alphabets at the ends of the signs can be omitted.

The terminal device 100A includes a first wireless communicator 110A, a first display 120A, a first operation section 130A, a photographing section 140A, and a first controller 150A.

The first wireless communicator 110A is an interface that performs wireless communication with external devices including the host device 200. The first wireless communicator 110A is configured by a network interface card such as a wireless LAN (Local Area Network) card. The first wireless communicator 110A performs the wireless communication with the external devices and transmits and receives various kinds of information.

The first display 120A includes a display panel 125A such as a Liquid crystal panel or an organic EL (Electro-Luminescence) panel and a driving circuit that drives the display panel 125A. Illustration of the driving circuit is omitted. A display signal is input to the first display 120A from the first controller 150A. The driving circuit of the first display 120A drives the display panel 125A based on the input display signal and causes the display panel 125A to display an image corresponding to the display signal.

The display panel 125A included in the terminal device 100A is equivalent to a first screen. A display panel 125B included in the terminal device 100B is equivalent to a second screen.

The first operation section 130A includes input devices such as a mouse and a keyboard and receives operation of a user. The first operation section 130A outputs an operation signal corresponding to the received operation to the first controller 150A.

The first operation section 130A may be configured by a touch panel that detects touch operation on the display panel 125A. In this case, the first operation section 130A outputs coordinate information of the display panel 125A indicating the position of the detected touch operation to the first controller 150A.

The photographing section 140A includes an image sensor such as a CCD (Charge Coupled Device) or a CMOS (Complementary Metal Oxide Semiconductor) and a data processing circuit that generates an image based on an electric signal output from the image sensor. Illustration of the image sensor and the data processing circuit is omitted.

The photographing section 140A generates, for example, a photographed image including a face of a user of the terminal device 100A and outputs the generated photographed image to the first controller 150A. The photographed image photographed by the photographing section 140A may be a moving image or may be a still image. The first controller 150A causes a first storage 160A to store the input photographed image.

The first controller 150A is a computer device including the first storage 160A and a first processor 170A and collectively controls the sections of the terminal device 100A.

The first storage 160A includes memories such as a RAM (Random Access Memory) and a ROM (Read Only Memory) . The RAM is used for temporary storage of various data and the like. The ROM stores control programs for controlling the operation of the terminal device 100 and various kinds of setting information. The control programs include application programs. The application programs are hereinafter simply referred to applications. The first storage 160A stores a plurality of applications including a client meeting application 165A. The client meeting application 165A is an application that the terminal device 100A uses to hold a meeting while sharing images with the host device 200 and the other terminal devices 100 coupled to the host device 200.

The first storage 160A may include an auxiliary storage device such as an SSD (Solid State Drive) or an HDD (Hard Disk Drive).

The first processor 170A is an arithmetic processing device configured by a CPU (Central Processing Unit) and an MPU (Micro-processing unit). The first processor 170A executes the control programs to control the sections of the terminal device 100A. The first processor 170A may be configured by a single processor or can also be configured by a plurality of processors.

The first processor 170A controls the first wireless communicator 110A and mutually performs data communication with external devices including the host device 200.

The first processor 170A executes the applications including the client meeting application 165A referring to the first storage 160A. The first processor 170A executes the client meeting application 165A to generate a capture image 55A explained below and transmit the capture image 55A to the host device 200.

An operation of the first processor 170A in executing the client meeting application 165A is explained below.

### 3. Configuration of the Host Device

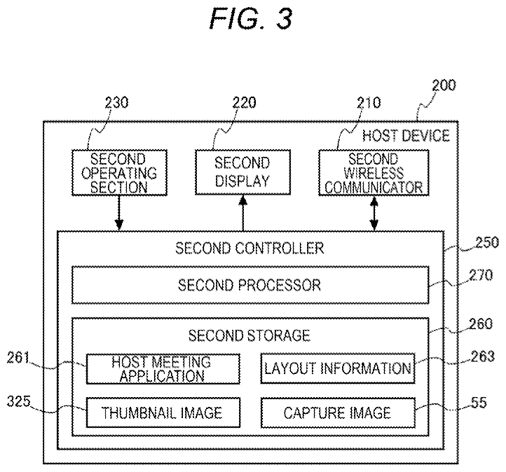

FIG. 3 is a block diagram showing the configuration of the host device 200.

The host device 200 includes a second wireless communicator 210, a second display 220, a second operation section 230, and a second controller 250.

Specific configurations of the second wireless communicator 210, the second display 220, and the second operation section 230 are the same as the specific configurations of the first display 120A and the first operation section 130A of the terminal device 100A. Therefore, detailed explanation of the specific configurations is omitted.

The second controller 250 is a computer device including a second storage 260 and a second processor 270 and collectively controls the sections of the host device 200.

The second storage 260 includes memories such as a RAM and a ROM. The second storage 260 may include an auxiliary storage device such as an SSD or an HDD.

The RAM is used for temporary storage of various data and the like. The ROM stores control programs for controlling the operation of the host device 200 and various kinds of setting information. The second storage 260 stores a host meeting application 261, capture images 55, thumbnail images 325, and layout information 263. The host meeting application 261 is an application for collectively controlling sharing of images between the terminal devices 100 and the host device 200, generation and transmission of the image for projection 15, and the like. The application in this embodiment is an application for a meeting. However, this use is an example. The application may be an application for a use other than the meeting. Applications stored in the first storage 160A or the second storage 260 can include various applications such as a document application, a spreadsheet application, an image editing application, and a moving image reproduction application. Applications other than the client meeting application 165A or the host meeting application 261 are hereinafter referred to as other applications.

The second processor 270 controls the second wireless communicator 210 to mutually perform data communication with the projector 50 and external devices including the terminal devices 100. A processor included in the host device 200 is hereinafter referred to as second processor 270. However, when it is necessary to distinguish processors of the terminal devices 100 by names, for example, a processor of the terminal device 100A may be referred to as first processor 170A, a processor of the terminal device 100B may be referred to as second processor 270B, and the processor of the host device 200 may be referred to as host processor.

The second processor 270 executes applications including the host meeting application 261 referring to the second storage 260. The second processor 270 executes the host meeting application 261 to thereby generate the image for projection 15 based on the capture images 55 received from the terminal device 100A. The capture images 55 are images generated by the first processor 170A capturing an image selected by the user. The second processor 270 performs generation and transmission of the thumbnail images 325, generation and transmission and reception of the layout information 263, and the like.

An operation of the second processor 270 in executing the host meeting application 261 is explained below.

### 4. Operation of the First Processor

### 4.1. Basic Operation

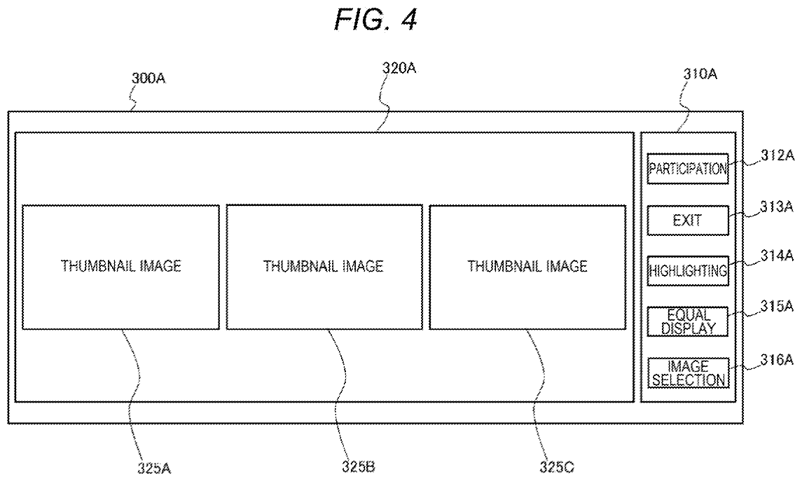

The operation of the first processor 170A that executes the client meeting application 165A is explained. As in the above explanation, the terminal device 100A is explained as an example. However, the terminal devices 100 have the same function as the function of the terminal device 100A and are capable of executing the same operation as the operation of the terminal device 100A. FIG. 4 is a diagram showing an example of an application image 300A displayed on the display panel 125A.

The application image 300A includes a button display region 310A and an image display region 320A.

In the button display region 310A, a participation button 312A, an exit button 313A, a highlighting button 314A, an equal display button 315A, and an image selection button 316A are displayed.

The participation button 312A is a button pressed when the terminal device 100A participates in a meeting.

The exit button 313A is a button pressed when the terminal device 100A exits the meeting.

The highlighting button 314A and the equal display button 315A are buttons pressed when a layout is manipulated. A change of the layout is explained below. The highlighting button 314A and the equal display button 315A are collectively referred to as layout buttons.

The image selection button 316A is a button pressed when a capture range 350A in the terminal device 100A is designated. The capture range 350A is explained below.

The thumbnail images 325 are images received by the terminal device 100A from the host device 200. Three thumbnail images 325 are shown in FIG. 4. The thumbnail images 325 are images generated by the host device 200 reducing the capture images 55 transmitted by the terminal devices 100 to the host device 200.

When the client meeting application 165A is started by operation of the user, first, the first processor 170A generates the application image 300A and causes the display panel 125A to display the application image 300A. Since the terminal device 100A is not participating in a meeting at this point in time, the thumbnail images 325 are not displayed in the image display region 320A.

When the participation button 312A is pressed, the first processor 170A transmits a request for participation in a meeting to the host device 200. When permitting the participation in the meeting, the host device 200 starts a session of the meeting. A method of starting the meeting is not limited. For example, when the participation button 312A is pressed, the first processor 170A may cause the user to input login information and the host device 200 may perform user authentication. The first processor 170A may acquire a list of meetings corresponding to the login information from the host device 200 and select a meeting in which the user of the terminal device 100A participates.

When the session of the meeting is started between the terminal device 100A and the host device 200, the first processor 170A transmits identification information of the terminal device 100A to the host device 200. The identification information is information used for identifying the terminal devices 100 and is information specific to each of the terminal devices 100. The identification information is, for example, MAC (Media Access Control) addresses or IP (Internet Protocol) addresses of the terminal devices 100. The first processor 170A receives size information indicating a size of the image for projection 15 from the host device 200. The size information is information indicating the width and the height of the image for projection 15. In the following explanation, the size means the width and the height unless particularly noted otherwise. The size information may be represented using, for example, resolution or a value in a normalized coordinate system obtained by normalizing a coordinate system of the image for projection 15. In the following explanation, the image for projection 15, the image display region 320A, and the display panel 125A are respectively represented by coordinate systems having origins at upper left. The coordinate information, the size information, and the like transmitted and received between the host device 200 and the terminal device 100A are represented using a normalized coordinate system having an origin at upper left and having lateral width normalized to 1.0. When receiving information indicating the size of the image for projection 15, the first processor 170A displays the image display region 320A at the same aspect ratio as an aspect ratio of the image for projection 15. When the coordinate information and the like are transmitted and received using the coordinate system of the image for projection 15 or the coordinate system of the image display region 320A, coordinate conversion only has to be performed as appropriate in a device that performs the transmission or a device that performs the reception.

When the session of the meeting is started, the first processor 170A receives designation of the capture range 350A by the user. The capture range 350A is information indicating a range of an image captured by the first processor 170A in an image generated by the terminal device 100A. The capture range 350A is represented by the coordinate system of the display panel 125A. When the image selection button 316A is pressed, the first processor 170A causes the display panel 125A to display an interface image 20 used to receive designation of the capture range 350A and receives operation by the user. The first processor 170A determines the capture range 350A based on the received operation of the user. The first processor 170A captures, at every predetermined time, an image included in the capture range 350A to thereby generate a capture image 55A. The first processor 170A associates the generated capture image 55A with the identification information of the terminal device 100A and transmits the capture image 55A to the host device 200. Size information of the capture image 55A represented by a normalized coordinate system is imparted to the capture image 55A to be transmitted. Capturable images include images generated by the terminal devices 100. For example, images generated by various applications including the client meeting application 165A and other applications and a photographed image photographed by the photographing section 140A are included. The images generated by the applications may be still images or may be moving images.

The capture image 55A output to the host device 200 by the terminal device 100A is equivalent to a first image. Like the terminal device 100A, the terminal device 100B, the terminal device 100C, and the terminal device 100D respectively output the capture images 55 to the host device 200. A capture image 55B output to the host device 200 by the terminal device 100B is equivalent to a second image. A capture image 55C output to the host device 200 by the terminal device 100C is equivalent to a third image. A capture image 55D output to the host device 200 by the terminal device 100D is equivalent to a fourth image.

When the session of the meeting is started, the first processor 170A starts reception of the layout information 263 and the thumbnail images 325 from the host device 200. The layout information 263 is information indicating a layout in displaying the thumbnail images 325 of the terminal devices 100 participating in the meeting. Specifically, the layout information 263 includes identification information of the terminal devices 100, coordinate information associated with the identification information, and size information of the thumbnail images 325. The coordinate information is coordinate information used to determine display positions of the thumbnail images 325 in the image display region 320A and is, for example, coordinates at upper left corners of the thumbnail images 325 in a normalized coordinate system. The size information of the thumbnail images 325 represents the width and the height of the thumbnail images 325 as values in the normalized coordinate system. The first processor 170A causes the first storage 160A to store the received layout information 263 and the received thumbnail images 325. The first processor 170A converts the size information of the thumbnail images 325 at the same magnification as magnification for converting the normalized coordinate system into a coordinate system of the image display region 320A, develops the thumbnail images 325 in positions in the image display region 320A corresponding to the coordinate information, and generates the application image 300A. The first processor 170A causes the display panel 125A to display the generated application image 300A. FIG. 4 is a display example of the application image 300A at this point in time. In FIG. 4, a thumbnail image 325A, a thumbnail image 325B, and a thumbnail image 325C are displayed based on the layout information 263.

The first processor 170A is capable of generating and transmitting the layout information 263. The first processor 170A receives operation of the user for designating a layout and generates the layout information 263 based on the received operation. The first processor 170A transmits the generated layout information 263 to the host device 200. The first processor 170A generates the application image 300A based on the generated layout information 263 and causes the display panel 125A to display the application image 300A.

### 4.2. Generation of the Layout Information by the First Processor

As explained above, the first processor 170A is capable of generating and transmitting the layout information 263 by executing the client, meeting application 165A. That is, the first processor 170A is capable of generating the layout information 263 based on operation of the user for designating display positions and display sizes of the thumbnail images 325 displayed on the application image 300A and transmitting the layout information 263 to the host device 200. Operation for designating highlighting, equal display, a position, and a size explained below is equivalent to operation for designating a layout.

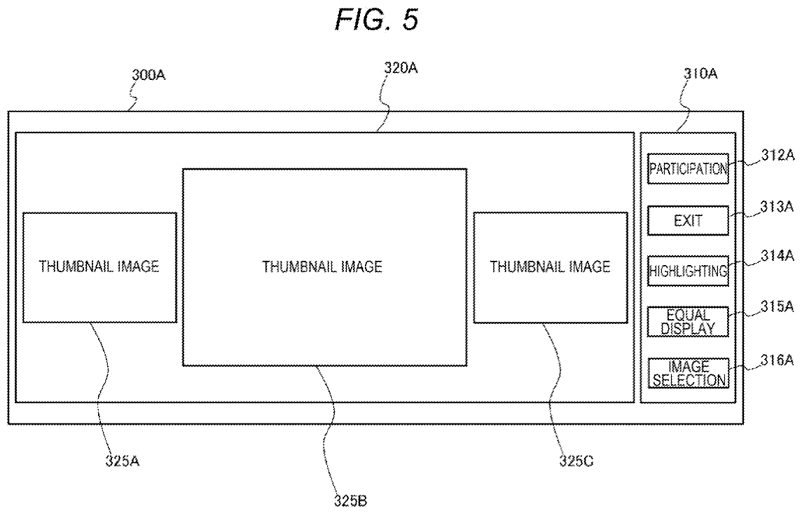

First, a basic operation example in controlling a layout using the highlighting button 314A is explained. FIG. 5 is a diagram showing the application image 300A. FIG. 5 is an example of a layout of the thumbnail images 325 at the time when highlighting is performed. In the following explanation. an operation of the terminal device 100A for generating the layout information 263 for highlighting the thumbnail image 325B is mainly explained with reference to FIG. 5. However, the same operation is possible when the other terminal devices 100 are used.

When receiving operation of the highlighting button 314A, the first processor 170A changes a layout of the image display region 320A to a layout of highlighting. In other words, when receiving operation of the highlighting button 314A among the layout buttons, the first processor 170A operates in a highlighting mode, which is one of layout modes.

When the highlighting button 314A is pressed, the first processor 170A receives operation for selecting the thumbnail image 325 to be enlarged and displayed among the thumbnail images 325 displayed in the image display region 320A. In the example shown in FIG. 5, the first processor 170A receives operation for selecting the thumbnail image 325 to be enlarged and displayed from the three thumbnail images 325A, 325B, and 325C. In this embodiment, the thumbnail image 325A that can be selected is not limited to the thumbnail image 325A corresponding to the terminal device 100A in which the operation is performed. The first processor 170A is capable of selecting the thumbnail images 325 of the other terminal devices 100. FIG. 5 is an example in the case in which the user selects the thumbnail image 325B. For example, the user selects the thumbnail image 325B by operating the first operation section 130A.

The first processor 170A generates the layout information 263 based on the received operation. Specifically, the first processor 170A designates, as a size of the selected thumbnail image 325B, a relatively larger value than a size of the unselected thumbnail images 325A and 325C to thereby generate new layout information 263 having size information of highlighting. Further, the first processor 170A may generate new coordinate information such that the selected thumbnail image 325B is arranged in the center of the image display region 320A. For example, when the thumbnail image 325B is present in a position of the image display region 320A in FIG. 5 before the selection, the first processor 170A may select the thumbnail image 325B to replace the position of the thumbnail image 325A or the thumbnail image 325C with the position of the thumbnail image 325B.

The first processor 170A overwrites the present layout information 263 stored in the first storage 160A with the new layout information 263. The first processor 170A generates a new application image 300A based on the new layout information 263 and causes the display panel 125A to display the new application image 300A. The first processor 170A transmits the new layout information 263 to the host device 200.

According to the operation explained above, the thumbnail image 325B is displayed in an increased size in the image display region 320A. That is, the thumbnail image 325B is highlighted. As explained in detail below, by transmitting the layout information 263 to the host device 200, the image for projection 15 and the application images 300 of the other terminal devices 100 are displayed in the same layout as the layout in the terminal device 100A. Therefore, the user of the terminal device 100A can designate, using the terminal device 100A of the user, layouts of the image for projection 15 and the application images 300 displayed on the terminal device 100B and the terminal device 100C. Therefore, the terminal device 100A receiving operation for designating a layout of the thumbnail images 325 in the image display region 320A is receiving operation for designating a layout of the capture images 55 in the image for projection 15 and a layout of the thumbnail images 325 in image display regions 320 of the other terminal devices 100.

In the highlighting, it is preferable to display all the thumbnail images 325 received from the host device 200 in the image display region 320A. It is preferable to keep an aspect ratio of the thumbnail images 325 at an aspect ratio of the thumbnail images 325 received from the host device 200. It is preferable that a size of the thumbnail image 325B in the highlighting is larger than a size of the thumbnail images 325 in displaying, in the equal display explained below, the thumbnail images 325 as many as the thumbnail images 325 in the highlighting. In this case, in the highlighting, the first processor 170A enlarges the thumbnail image 325B to a size larger than the size of the thumbnail images 325 in the equal display and reduces the thumbnail image 325B and the thumbnail image 325C to a size smaller than the size in the equal display. Consequently, as shown in FIG. 5, all of the enlarged thumbnail image 325B and the reduced thumbnail images 325A and 325C are displayed in the image display region 320A. In the highlighting, the first processor 170A may not change the size of the thumbnail image 325B and may reduce the size of the thumbnail image 325A and the thumbnail image 325C.

The pressing of the highlighting button 314A and the selection of the thumbnail image 325 may be performed in order opposite to the order described above. That is, when the highlighting button 314A is pressed in a state in which the thumbnail image 325B is selected, the first processor 170A may highlight the thumbnail image 325B being selected. The thumbnail image 325 corresponding to the terminal device 100 in which the highlighting button 314A is pressed may be highlighted. For example, when the highlighting button 314A is pressed, the first processor 170A enlarges and displays the thumbnail image 325A associated with identification information corresponding to the terminal device 100A. In this case, selection of the thumbnail image 325 can be omitted.

Referring back to FIG. 4, an example in which a layout is controlled using the equal display button 315A is explained. In FIG. 4, a layout of the thumbnail images 325 equally displayed is shown. When the equal display button 315A is pressed, the first processor 170A changes the layout of the image display region 320A to a layout of the equal display. In other words, when receiving operation of the equal display button 315A among the layout buttons, the first processor 170A operates in an equal display mode, which is one of the layout modes.

When the equal display button 315A is pressed, the first processor 170A generates new layout information 263. Specifically, the first processor 170A designates the same size as sizes of all the thumbnail images 325 to thereby generate new layout information 263 having size information of the equal display. As in the case of the highlighting, the first processor 170A updates the layout information 263 of the first storage 160A, generates a new application image 300A, and causes the display panel 125A to display the new application image 300A. The first processor 170A transmits the new layout information 263 to the host device 200.

For example, when the equal display button 315A is pressed when the layout of the image display region 320A is the layout of the highlighting, the first processor 170A ends the highlighting and performs the equal display. That is, the thumbnail image 325B enlarged as shown in FIG. 5 and the thumbnail images 325A and 325C reduced as shown in FIG. 5 are displayed in the same size as shown in FIG. 4. When the highlighting is changed to the equal display, order of arrangement of the thumbnail images 325 in the equal display may be the same as order of arrangement of the thumbnail images 325 in the immediately preceding highlighting. In this case, the first processor 170A determines coordinate information of the thumbnail images 325 in new layout information referring to layout information in the immediately preceding highlighting. When the equal display button 315A is pressed, the first processor 170A may arrange the thumbnail images 325 in initial arrangement order, for example, order at the time when the meeting is started. In this case, the first processor 170A stores at least first layout information in the first storage 160A and, when the equal display button 315A is pressed, determines new coordinate system referring to the first layout information.

In the case of the equal display, it is preferable from the viewpoint of visibility, sizes of the thumbnail images 325 are the largest sire in which all the thumbnail images 325 can be displayed in the same size in the image display region 320A. In FIG. 4, sizes of the thumbnail images 325A, 325B, and 325C displayed in the image display region 320A are the same and the largest. In FIG. 4, the thumbnail images 325A, 325B, and 325C of the same size are displayed side by side in a row. In FIG. 4, an example is shown in which the thumbnail images 325A, 325B, and 325C are laterally arranged in a row. However, an array of the thumbnail images 325A, 325B, and 325C only has to be determined according to an aspect ratio of the image display region 320A. The thumbnail images 325A, 325B, and 325C may be longitudinally arranged in a row. It is also possible to array the thumbnail images 325 in a M×N matrix shape according to the number of users participating in the meeting, that is, the number of thumbnail images 325. M and N are integers equal to or larger than 1.

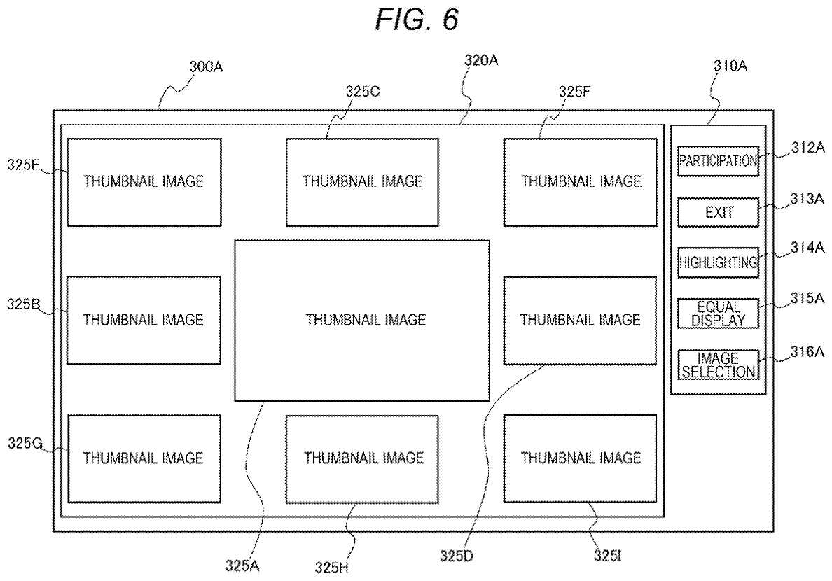

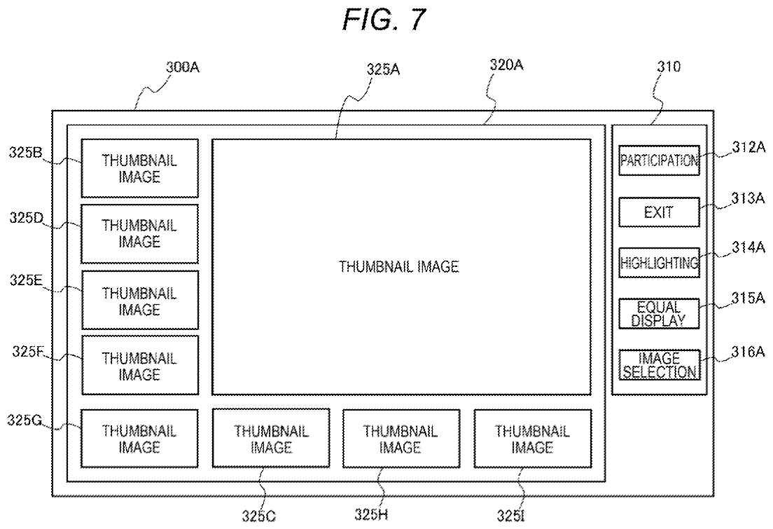

Subsequently, another example of the highlighting is explained. FIGS. 6 and 7 are diagrams showing the application image 300A. FIGS. 6 and 7 show examples of a layout of the thumbnail images 325 at the time when the highlighting button 314A is pressed. FIGS. 6 and 7 are display examples at the time when nine terminal devices 100, that is, terminal devices 100A to 100I are participating in a meeting.

In the layout illustrated using FIG. 6, a region for arranging the unselected thumbnail images 325 is provided around four sides of the thumbnail image 325 arranged in the center. In FIG. 6, nine thumbnail images 325, that is, thumbnail images 325A to 325I are shown. FIG. 6 is an example in which the thumbnail image 325A is selected and highlighted. However, any one of the thumbnail images 325A to 325I may be selected. The same applies to FIG. 7. In a layout of the image display region shown 320A in FIG. 6, the other thumbnail images 325B to 325I are arranged around the enlarged thumbnail image 325A.

A positional relation among the thumbnail images 325 in FIG. 6 is explained below based on a direction in which the user visually recognizes the application image 300A. That is, it is assumed that above, below, left, and right in the following explanation coincide with above, below, left, and right of character strings displayed in the bottom display region 310A.

The thumbnail image 325C is arranged above the thumbnail image 325A. The thumbnail image 325H is arranged below the thumbnail image 325A.

The thumbnail image 325B is arranged on the left of the thumbnail image 325A. The thumbnail image 325D is arranged on the right of the thumbnail image 325A.

The thumbnail image 325E is arranged obliquely above on the left of the thumbnail image 325A. The thumbnail image 325F is arranged obliquely above on the right of the thumbnail image 325A.

The thumbnail image 325G is arranged obliquely below on the left of the thumbnail image 325A. The thumbnail image 325I is arranged obliquely below on the right of the thumbnail image 325A.

The thumbnail image 325E, the thumbnail image 325C, and the thumbnail image 325F are arranged in a row in the lateral direction of the image display region 320A on the upper side of the thumbnail image 325A.

The thumbnail image 325G, the thumbnail image 325H, and the thumbnail image 325I are arranged in a row in the lateral direction of the image display region 320A on the lower side of the thumbnail image 325A.

The thumbnail image 325E, the thumbnail image 325B, and the thumbnail image 325G are arranged in a row in the longitudinal direction of the image display region 320A on the left side of the thumbnail image 325A.

The thumbnail image 325F, the thumbnail image 325D, and the thumbnail image 325I are arranged in a row in the longitudinal direction of the image display region 320A on the right side of the thumbnail image 325A.

FIG. 7 also shows an example in which the nine thumbnail images 325, that is, the thumbnail images 325A to 325I are displayed and the selected thumbnail image 325A is enlarged and displayed. In a layout illustrated using FIG. 7, a region for arranging the unselected thumbnail images 325 is provided around continuous two sides of the selected thumbnail image 325A. The thumbnail image 325A is arranged from the center to the upper right part of the image display region 320A of the application image 300A. The other thumbnail images 325 are not arranged on the upper side and the right side of the thumbnail image 325A. The other thumbnail images 325B to 325I are arranged on the left of or/and below the enlarged thumbnail image 325A.

In FIG. 7, the thumbnail images 325B, 325D, 325E, 325F, and 325G are arranged in a row along the longitudinal direction of the image display region 320A on the left side of the thumbnail image 325A.

The thumbnail images 325G, 325C, 325H, and 325I are arranged in a row along the lateral direction of the image display region 320A on the lower side of the thumbnail image 325A. Positions where the unenlarged thumbnail images 325 are arranged are not limited to the left side and the lower side of the thumbnail image 325A.

The first processor 170A may determine, according to the number of thumbnail images 325 and an aspect ratio of the image for projection 15, which of the layouts illustrated in FIGS. 5, 6, and 7 is used to perform the highlighting. For example, the first processor 170A may select, based on the aspect ratio of the image for projection 15 and the number of thumbnail images 325, a layout in which the sizes of the thumbnail images 325 are the largest. The first processor 170A may select a layout in which the sizes of highlighting thumbnail images 325 are largest. The first processor 170A may determine a layout of the highlighting according to the position of the selected thumbnail image 325. For example, when the thumbnail images 325A to 325I are arranged in a matrix, the thumbnail image 325A in the center may be highlighted in the layout shown in FIG. 6 when being selected and the thumbnail image 325C on the upper right may be highlighted, when being selected, in a layout in which the thumbnail image 325C is arranged in the position of the thumbnail image 325A shown in FIG. 7.

The first processor 170A may determine, based on operation of the user, a layout used for the highlighting. For example, the first processor 170A may display a layout selection image for presenting candidates of the layout in the highlighting and cause the user to select a layout. Illustration of the layout selection image is omitted. The first processor 170A may display the layout selection image when the highlighting button 314A is pressed or the user may invoke the layout selection image using a not-shown setting button. The first processor 170A may transmit a layout of the highlighting designated by the host device 200 to the terminal device 100 or may use a common layout in the host device 200 and all the terminal devices 100.

Another example in which the first processor 170A generates the layout information 263 is explained. In this example, a user is capable of optionally designating positions and sizes of the thumbnail images 325 by operating the first operation section 130A. These control methods may be able to be selected by pressing a not-shown button or may be executed when operation explained below is performed after the highlighting button 314A is pressed. The first processor 170A may receive the operation explained below without button operation. As in the example explained above, the first processor 170A generates the layout, information 263 and transmits the layout information 263 to the host device 200 according to operation of the user. The first processor 170A generates the application image 300A and causes the display panel 125A to display the application image 300A according to operation of the user,

For example, the user may move the thumbnail images 325 with drag and drop operation. The user touches, with a finger, one of the thumbnail images 325 displayed on the application image 300A and moves the finger on the display panel 125A. The first processor 170A moves a display position of the selected thumbnail image 325 according to the movement of the finger of the user. The first processor 170A generates new coordinate information in which a position where the user releases the finger is a new position of the thumbnail image 325.

For example, the user may change the sizes of the thumbnail images 325 with enlarging and reducing operation such as pinch-in and pinch-out. The user performs operation for touching, with two fingers, one of the thumbnail images 325 displayed on the application image 300A and widening or narrowing an interval of the two fingers. The first processor 170A increases or reduces the size of the selected thumbnail image 325 with an amount of change corresponding to a change of the interval between the two fingers of the user and generates new layout information 263 including new size information.

### 4.3. Generation of the Capture Image

The operation of the first processor 170A at the time when the image selection button 316A is pressed is explained. As explained above, the first processor 170A determines the capture range 350A, which is a range of an image, based on operation of the user and captures an image included in the capture range 350A and transmits the image to the host device 200.

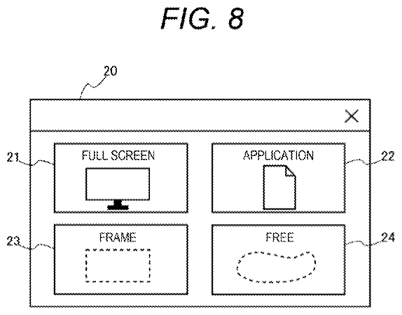

FIG. 8 is an example of the interface image 20 used to receive designation of the capture range 350A. When the image selection button 316A is pressed, the first processor 170A displays the interface image 20 on the application image 300A.

The client meeting application 165A has a plurality of modes for designating the capture range 350A. The plurality of modes include a full screen selection mode, an application selection mode, a frame selection mode, and a free selection mode. The modes for designating the capture range 350A are collectively referred to as designation modes below. A designation mode used by the terminal device 100A is equivalent to a first terminal mode. The terminal device 100B receives operation for selecting a designation mode like the terminal device 100A. A designation mode used by the terminal device 100B is equivalent to a second terminal mode. The capture range 350A in the terminal device 100A is equivalent to a first range and a capture range 350B in the terminal device 100B is equivalent to a second range. Since the terminal devices 100 are capable of selecting the designation modes independently from one another, the plurality of terminal devices 100 may select the same designation mode or may select different designation modes.

The interface image 20 is a user interface image for receiving selection of any one of the designation modes. In FIG. 8, a full screen selection button 21, an application selection button 22, a frame selection button 23, and a free selection button 24 respectively corresponding to the designation modes explained above are shown. The user selects one of the buttons using the first operation section 130A. The first processor 170A determines the button selected by the user to thereby receive the selection of the designation mode. The frame selection mode and the free selection mode are equivalent to a first mode. The application selection mode is equivalent to a second mode. The full screen selection mode is equivalent to a third mode.

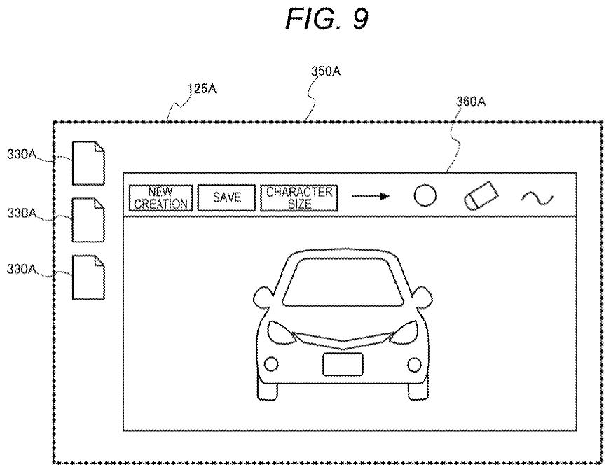

FIGS. 9 to 12 are diagrams showing setting examples of the capture range 350A. In FIGS. 9 to 12, an entire image displayed on the display panel 125A is shown. In the examples shown in FIGS. 9 to 12, images displayed on the display panel 125A include an application images 360A generated by another application and icons 330A of various applications. The capture range 350A is indicated by a broken line. The four designation modes are explained below with reference to FIGS. 9 to 12.

FIG. 9 is a setting example of the capture range 350A in the full screen selection mode. The full screen selection mode is a mode for setting, as the capture range 350A, an entire image displayed on the display panel 125. When the full screen selection button 21 is pressed, the first processor 170A shifts to the full screen selection mode. In the full screen selection mode, the first processor 170A sets, as the capture range 350A, an entire image displayed on the display panel 125A. The first processor 170A may minimize the application image 300A or make the application image 300A transparent to thereby cause the user to visually recognize an image on the display panel 125 set as the capture range 350A. At this time, a frame line shown in FIG. 9 may be displayed on the outer periphery of the display panel 125. The display of the capture image 55A may not be performed in the full screen selection mode.

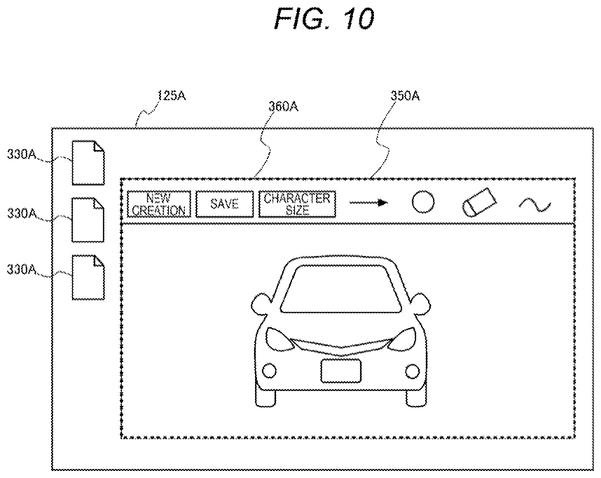

FIG. 10 is a setting example of the capture range 350A in the application selection mode. The application selection mode is a mode for receiving selection of an application by the user and setting, as the capture range 350A, an image generated by the selected application. In the application selection mode, it is possible to select an application if the application is executable by the terminal device 100A. When the application selection button 22 is pressed, the first processor 170A shifts to the application selection mode. The first processor 170A displays a not-shown application selection screen. The first processor 170A causes the application selection screen to display a list of applications in operation and receives operation of the user for selecting an application. The user operates the first operation section 130A and selects an application from a list of applications. The first processor 170A sets, as the capture range 350A, an entire image generated by the selected application. FIG. 10 is an example in the case in which the image editing application is selected in the application selection mode. The application image 360A generated by the image editing application is set as the capture range 350A. The capture range 350A in the application selection mode is a coordinate system of a region of the first storage 160A in which the application image 360A is drawn. Even if the application image 360A is not displayed on the display panel 125A, the first processor 170A is capable of capturing the application image 360A. In the application selection mode, as in the full screen selection mode, the first processor 170A may display the capture image 55A and cause the user to visually recognize the capture image 55A or may not perform the display.

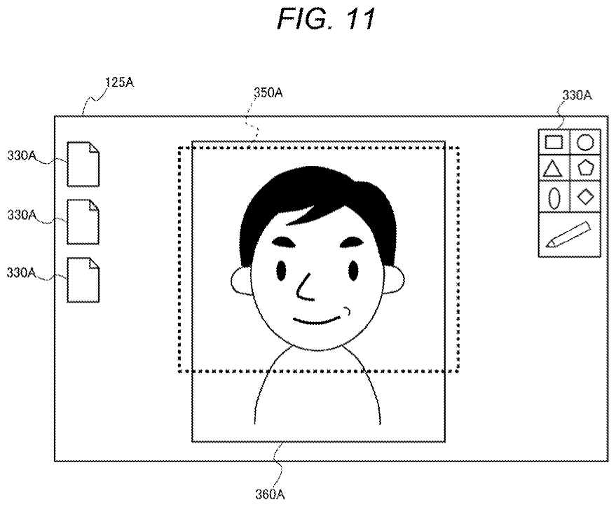

FIG. 11 is a setting example of the capture range 350A in the frame selection mode. The frame selection mode is a mode in which the user designates a shape and a position of the capture range 350A on the display panel 125A to set the capture range 350A. The first processor 170A receives a drawn image of a frame indicating the shape and the position of the capture range 350A to thereby determine the capture range 350A. The first processor 170A receives operation of the user for designating a shape of the frame and a position on the display panel 125A where the frame is arranged. The shape of the frame includes a geometrical shape and a size of the frame. When the frame is not rectangular, the size may be represented by, for example, a size of a rectangle circumscribing the frame. When the frame selection button 23 is pressed, the first processor 170A shifts to the frame selection mode and causes the display panel 125A to display the operation icons 330A. At this time, as shown in FIG. 11, the first processor 170A may minimize the application image 300A or make the application image 300A transparent to thereby enable the user to visually recognize an image other than the application image 300A displayed on the display panel 125A. The same applies to the free selection mode explained below.

Selectable shapes of the frame include various shapes such as a rectangle, a circle, an ellipse, and a polygon. Figures representing selectable shapes of a plurality of frames are displayed on the operation icons 330A. The user selects a figure having a desired shape out of the figures displayed on the operation icons 330A. Subsequently, the user draws, on the display panel 125A, the selected figure in a desired position and a desired size with operation of the mouse or the like. For example, as shown in FIG. 11, the first processor 170A causes the display panel 125A to display a track drawn by the user. The user may manipulate the drawn figure to thereby change the position and the size of a figure once drawn. When the user ends the drawing of the figure, the first processor 170A sets, as the capture range 350A, the inner side of a frame defined by the shape and the position of the created figure on the display panel 125A.

In FIG. 11, an image generated by a camera application referring to the first storage 160A is displayed as the application image 360A and a part of the application image 360A is surrounded by a square frame and set as the capture range 350A. Since the first processor 170A captures an image included in the capture range 350A, in the frame selection mode, a portion on the inner side surrounded by the frame in an image displayed on the display panel 125A is captured. Therefore, as shown in FIG. 11, a part surrounded by the frame in the application image 360A can be set as the capture image 55A. A range including the part of the application image 360A and another image displayed on the display panel 125A may be set as the capture range 350A. In the frame selection mode, since a range on the display panel 125A is designated, for example, it is also possible to display or not display a desired image in the capture range 350A by moving the position of a window of an application displayed on the display panel 125A.

In the frame selection mode, the positions of vertexes where the frame is arranged may be designated on the display panel 125A and a desired frame may be set on the display panel 125A. For example, when the shape of the frame is a rectangle or a polygon, the user designates the positions of the vertexes of the frame in order. In the frame selection mode, the user may designate the shape of the frame with an aspect ratio.

Further, a mask image may be used as an image representing a frame in the frame selection mode. The mask image is an image having the same resolution as the resolution of the display panel 125A. Pixels of the mask image have a value of 0 or 1. If the value is 0, the value represents pixels in the capture range 350A. If the value is 1, the value represents pixels not in the capture range 350A. 0 and 1 may be opposite. A region where the value is 1 is referred to as mask, in this case, the shape of the capture image 55A is a designated shape of the mask. A contour of the mask, that is, a boundary between the region where the value of the pixels is 1 and a region where the value is 0 is equivalent to the frame. The position is the position of the display panel 125A where the mask is arranged.

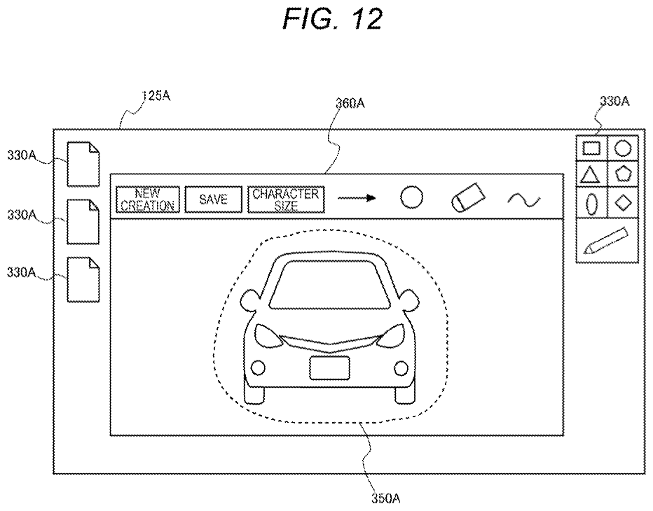

FIG. 12 is a setting example of the capture range 350A in the free selection mode. The free selection mode is a mode for setting a frame indicating the capture range 350A on the display panel 125A as in the frame selection mode. However, the frame selection mode is different from the frame selection mode in that the user draws a shape of the frame to determine the shape. The user designates, with operation of the mouse or touch on the display panel 125A, a range of an image desired to be displayed as the capture image 55A. In the free selection mode, the selection of a shape of the frame in the frame selection mode is not performed. The user moves the mouse or the finger to draw a frame and surround the range of the image desired to be displayed as the capture image 55A to designate the capture range 350A. In the example shown in FIG. 12, the first processor 170A shifts to the free selection mode when the user selects an icon of a pen displayed on the operation icon 330A. The first processor 170A may operate in the free selection mode when a shape of the frame is not selected in the operation icon 330A and drawing is performed on the display panel 125A. In FIG. 12, a part of the application image 360A, specifically, a portion where an automobile is drawn in the application image 360A displayed by the image editing application is surrounded by the frame to be set as the capture range 350A.

The terminal device 100A detects a track of the mouse or the finger moved on the display panel 125A and generates track data. The track data is a set of points pointed in the drawing. The track data includes information indicating coordinates of the points forming the track and order of designation of the points. When a start point and an end point coincide in the track data, the terminal device 100A determines whether the pixels of the display panel 125A are inside or outside the contour indicated by the track data. The terminal device 100A sets, as the capture range 350A, the pixels determined are being on the inner side of the contour indicated by the track data. The terminal device 100A captures an image included in the capture range 350A and generates the capture image 55A. In this case, the shape and the size of the frame are represented by freely selected coordinates and order of the coordinates, that is, the track data. The position of the frame is represented by the position of the start point of the track.

### 5. Operation of the Second Processor 270

The operation of the second processor 270 is explained.

When the host meeting application 261 is started by operation of the user who uses the host device 200, the second processor 270 receives requests for participation in a meeting from the terminal devices 100. When receiving the request for participation in the meeting from the terminal device 100A, the second processor 270 starts a session of the meeting when permitting the participation in the meeting. The second processor 270 acquires identification information of the terminal device 100A and causes the second storage 260 to store the identification information of the terminal device 100A. The host device 200 transmits size information of the image for projection 15 to the terminal device 100A. When receiving the capture image 55A from the terminal device 100A, the host device 200 reduces the received capture image 55A while keeping an aspect ratio to thereby generate the thumbnail image 325A. The host, device 200 causes the second storage 260 to store the capture image 55A, the thumbnail images 325A, and the identification information of the terminal device 100A in association with one another. Every time the second processor 270 receives a request for participation in the meeting from a new terminal device 100, the second processor 270 executes the operation explained above. Every time the second processor 270 receives a new capture image 55A from the terminal device 100A, the second processor 270 generates a new thumbnail image 325A and updates the capture image 55A and the thumbnail image 325A stored in the second storage 260.

Subsequently, the host device 200 generates the layout information 263. The host device 200 determines, based on, for example, the number of kinds of identification information, the number of terminal devices 100 participating in the meeting. The host device 200 generates the layout information 263 in a layout corresponding to the number of terminal devices 100. In this embodiment, the layout information 263 generated by the second processor 270 first is layout information of the equal display. First, the second processor 270 determines an array for arranging the thumbnail images 325. The array is represented by, for example, the numbers of rows and columns of a matrix array and coordinate information indicating positions of the array. The second processor 270 may determine, based on, for example, the number of terminal devices 100 and an aspect ratio of the image display region 320A, an array in which the thumbnail images 325 can be displayed in the largest size when all the thumbnail images 325 are displayed in the same size. The second processor 270 may cause the second display 220 to display an input screen for candidates of the array or the number of rows and the number of columns of matrix arrangement and determine a layout based on an input of the user.

Subsequently, the second processor 270 associates coordinates of the determined array and the identification information of the terminal devices 100 each other to generate the layout information 263. The second processor 270 causes the second storage 260 to score the generated layout information 263. A combination of the coordinates and the identification information is optional. However, for example, the identification information may be associated in order of reception of requests for participation in the meeting by the host device 200 from one end of the array.

For example, when the number of terminal devices 100 is one, the number of rows and the number of columns are determined as one. The coordinate information is a coordinate of the center of the image display region 320. Therefore, the layout information 263 in which one thumbnail image 325 is arranged in the center of the image display region 320 is generated.

When the number of terminal devices 100 is three, for example, as shown in FIG. 4, the host device 200 selects an array in which three thumbnail images 325A, 325B, and 325C are arranged in one row and three columns. It is assumed that the host device 200 receives requests for participation in the meeting from the terminal device 100A, the terminal device 100B, and the terminal device 100C in this order. When the thumbnail images 325 are arranged in the order of the reception of the participation requests, the second processor 270 generates the layout information 263 in which identification information of the terminal device 100A and a coordinate at the left end of the array are associated, the terminal device 100B and a coordinate of the center of the array are associated, and the terminal device 100C and a coordinate of the right end of the array are associated. Consequently, as shown in FIG. 4, the layout information 263 in which the thumbnail image 325A, the thumbnail image 325B, and the thumbnail image 325C are arranged in order from the left in the image display region 320A can be obtained.

The host device 200 reads out the generated layout information 263 and the thumbnail images 325 associated with the layout information 263 from the second storage 260 and transmits the layout information 263 and the thumbnail images 325 to the terminal devices 100 participating in the meeting.

When receiving the layout information 263 from the terminal devices 100 participating in the meeting, the second processor 270 overwrites the layout information 263 stored in the second storage 260 with the received layout information 263. The second processor 270 reads out the received layout information 263 and the thumbnail images 325 from the second storage 260. The second processor 270 transmits the received layout information 263 and the thumbnail images 325 to the terminal devices 100 participating in the meeting. The terminal devices 100 respectively generate the application images 300 using the received layout information 263 and display the application images 300 on the display panels 125. Consequently, the thumbnail, images 325 are displayed in the same layout in all the terminal devices 100 participating in the meeting.

The second processor 270 arranges, according to the layout information 263 stored in the second storage 260, the capture images 55 received at every fixed interval from the terminal devices 100 participating in the meeting and generates the image for projection 15. The layout Information 263 is also information indicating display positions of the capture images 55 included in the image for projection 15 displayed on the projection surface 10. The host device 200 develops the capture images 55 received from the terminal devices 100 in arrangement corresponding to the layout information 263 and generates the image for projection 15. The second processor 270 transmits the generated image for projection 15 to the projector 50. The projector 50 displays the received image for projection 15 on the projection surface 10. Consequently, the image for projection 15 is displayed on the projection surface 10 by the projector 50.

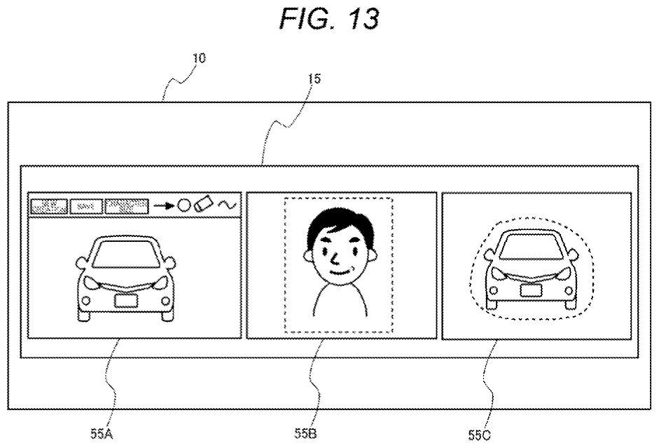

FIG. 13 is a diagram showing the image for projection 15 displayed on the projection surface 10. The capture images 55A to 55C respectively correspond to the thumbnail images 325A to 325C. FIG. 13 shows the image for projection 15 in a layout corresponding to the layout of the thumbnail images 325 shown in FIG. 4.

In FIG. 13, an example of the capture images 55 obtained when the plurality of terminal devices 100 designate different capture ranges 350 is shown. The terminal device 100A is in the application selection mode. In the example shown in FIG. 13, the capture image 55A of the application image 360A shown in FIG. 9 is shown. The terminal device 100B is in the frame selection mode. The capture image 55B is an example in the case in which the terminal device 100B displays the application image 360B that is the same as the application image 360A shown in FIG. 11 and sets the capture range 350B that is the same as the capture range 350A shown in FIG. 11. The terminal device 100C is in the free selection mode. The capture image 55C is an example in the case in which the terminal device 100C displays the application image 360C that is the same as the application image 360A shown in FIG. 12 and sets the capture range 350C that is the same as the capture range 350A shown in FIG. 12.

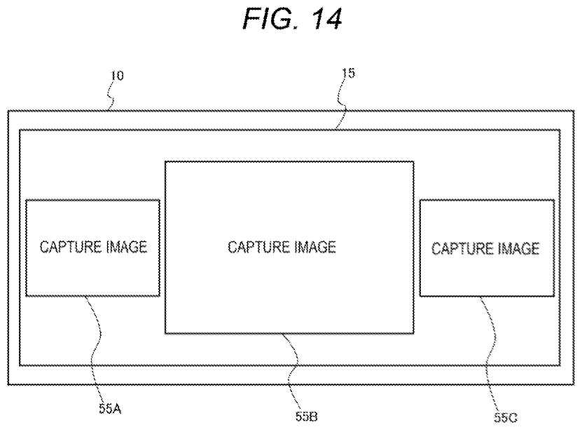

FIG. 14 shows the image for projection 15 in a layout corresponding to the layout of the thumbnail images 325 shown in FIG. 5. When the terminal device 100A transmits the layout information 263 of the layout shown in FIG. 5 to the host device 200, the host device 200 generates the image for projection 15 using the received layout information and outputs the image for projection 15 to the projector 50. As a result, as shown in FIG. 14, the image for projection 15 in which the capture images 55 are arranged side by side in the same layout as the layout shown in FIG. 5 is displayed on the projection surface 10. Since FIG. 5 is the layout of the highlighting in which the thumbnail image 325B is enlarged, in FIG. 14, the capture image 55B corresponding to the thumbnail image 325B is highlighted.

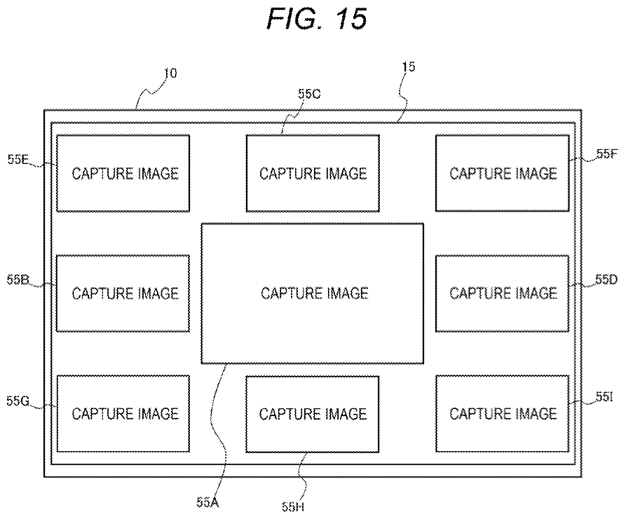

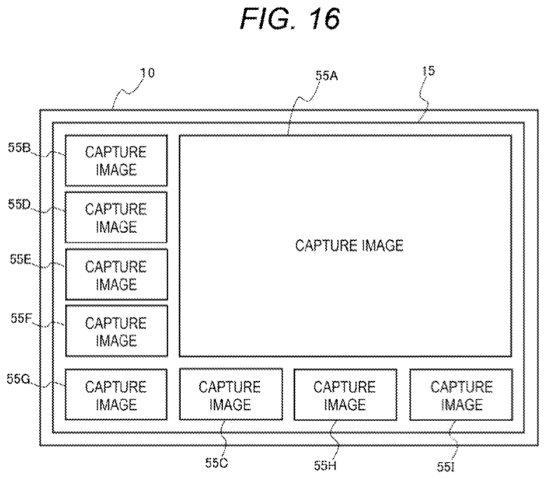

FIGS. 15 and 16 are diagrams showing the image for projection 15 displayed on the projection surface 10. Capture images 55A to 55I respectively correspond to the thumbnail images 325A to 325I.

FIG. 15 shows the image for projection 15 in a layout corresponding to the layout of the thumbnail images 325 shown in FIG. 6. The host device 200 displays the image for projection 15 on the projection surface 10 using the layout information 263 in the layout shown in FIG. 6 received from the terminal device 100A. Since FIG. 6 is the layout of the highlighting in which the thumbnail image 325A is enlarged, in FIG. 15, the capture image 55A corresponding to the thumbnail image 325A is highlighted. A positional relation among the capture images 55A to 55I in FIG. 15 is the same as the positional relation among the thumbnail images 325A to 325I in FIG. 6.

In FIG. 15, the capture image 55A is equivalent to the first image. The capture image 55B is equivalent to the second image arranged laterally to the capture image 55A. The capture image 55D is equivalent to the fourth image arranged on the opposite side of the capture image 55B. The capture image 55C is equivalent to the third image arranged longitudinally to the capture image 55A. In the layout shown in FIG. 6, any one of the capture images 55E, 55F, 55G, and 55I may be the second image or the fourth image. The capture image 55H may be the third image.

FIG. 16 shows the image for projection 15 in a layout corresponding to the layout of the thumbnail images 325 shown in FIG. 7. The host device 200 displays the image for projection 15 on the projection surface 10 using the layout information 263 in the layout shown in FIG. 7 received from the terminal device 100A. Since FIG. 7 is the layout of the highlighting in which the thumbnail image 325A is enlarged, in FIG. 16, the capture image 55A is highlighted. A positional relation among the capture images 55A to 55I in FIG. 16 is the same as the positional relation among the thumbnail images 325A to 325I in FIG. 7.

In FIG. 16. the capture image 55A is equivalent to the first image. The capture image 55B is equivalent to the second image arranged laterally to the first image. The capture image 55D is equivalent to the fourth image arranged on the same side as the second image. The capture image 55C is equivalent to the third image arranged longitudinally to the capture image 55A. In the layout shown in FIG. 7, any one of the capture images 55D to 55G may be the second image or the fourth image. Any one of the capture images 55G to 55I may be the third image.

### 6. Operation Flowchart of the Terminal Device

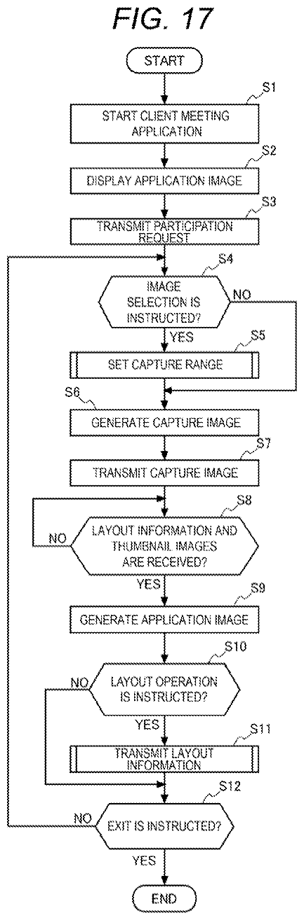

FIGS. 17, 18, and 19 are flowcharts showing the operation of the terminal device 100A.

The operation of the terminal device 100A is explained with reference to the flowcharts of FIGS. 17, 18, and 19.

FIG. 17 is a flowchart showing an overview of the operation of the terminal device 100A. The first controller 150A starts the client meeting application 165A (step S1) . For example, when the client meeting application 165A is selected by operation of the user, the first controller 150A starts the client meeting application 165A.

After starting the client meeting application 165A, the first controller 150A causes the display panel 125A to display the application image 300A (step S2) . Subsequently, the first controller 150A transmits a request for participation in a meeting (step S3). When a session of the meeting is started, the first controller 150A transmits identification information of the terminal device 100A and receives information indicating a size of the image for projection 15 from the host device 200.

Subsequently, the first controller 150A determines whether image selection is instructed (step S4) . For example, when the image selection button 316A is pressed, the first controller 150A determines that the image selection is instructed (YES in step S4), performs processing for setting the capture range 350A (step S5), and shifts to step S6. Details of the processing for setting the capture range 350A are explained below. When the image selection button 316A is not pressed, the first controller 150A determines that the image selection is not instructed (NO in step S4) and shifts to step S6 without performing step S5.

Subsequently, the first controller 150A captures an image in the capture range 350A set in steps S52 to S55 and generates the capture image 55A (step S6) . Since a range set as the capture range 350A is different according to a designation mode, the capture image 55A generated in step S6 is different depending on the designation mode determined in step S5. When determining that the image selection is not instructed (NO in step S4), in step S6, the first controller 150A generates the capture image 55A based on the capture range 350A set in the past. The first controller 150A transmits the generated capture image 55A to the host device 200 (step S7). The first controller 150A shifts to step S8. When the first controller 150A determines in step S4 immediately after step S3 that the image selection is not instructed (NO in step S4), the capture range 350A is not set. In this case, the first controller 150A may skip steps S6 and S7 and shift to step S8 or may set the capture range 350A in the third mode and execute steps S6 and S7.

Subsequently, the first controller 150A determines whether the layout information 263 and the thumbnail images 325 are received from the host device 200 (step S8). When determining that the layout information 263 and the thumbnail images 325 are not received (NO in step S8), the first controller 150A stays on standby until the layout information 263 and the thumbnail images 325 are received. When determining that the layout information 263 and the thumbnail images 325 are received (YES in step S8), the first controller 150A develops the thumbnail images 325 in the image display region 320A according to the received layout information 263 to generate the application image 300A and causes the display panel 125A to display the generated application image 300A (step S9).

Subsequently, the first controller 150A determines whether layout operation is instructed (step S10). When the layout button is pressed, the first controller 150A determines that the layout operation is instructed (YES in step S10), performs processing for transmitting the layout information 263 to the host device 200 (step S11), and shifts to step S12. Details of the processing for transmitting the layout information 263 are explained below, when the layout button is not pressed, the first controller 150A determines that the layout operation is not instructed (NO in step S10) and shifts to step S12 without performing step S11.

The first controller 150A determines whether exit is instructed (step S12). When the exit button 313A is pressed, the first controller 150A determines that the exit is instructed (YES in step S12), ends the display of the thumbnail images 325 in the image display region 320A and the communication of the terminal device 100A and the host device 200, and ends the processing flow. When the exit button 313A is not pressed, the first controller 150A determines that the exit is not instructed (NO in step S12) and returns to the determination in step S4.

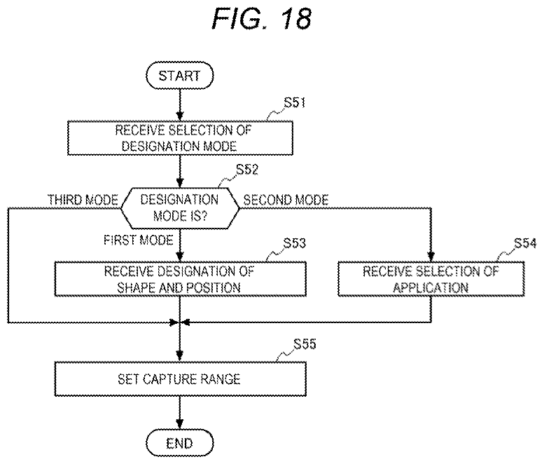

Subsequently, the processing for setting the capture range 350A in step S5 is explained in detail with reference to FIG. 18. When determining that the image selection is instructed (YES in step S4), the first controller 150A causes the display panel 125A to display the interface image 20 and receives selection of a designation mode by the user (step S51). When receiving selection operation on the interface image 20, the first controller 150A determines whether the selected designation mode is the first mode, the second mode, or the third mode (step S52).

When determining that the selected designation mode is the first mode (first mode in step S52), the first controller 150A receives operation for designating a shape and a position of the capture range 350A (step S53). For example, the first controller 150A receives drawing operation of the user on the display panel 125A. The first controller 150A sets the capture range 350A using the shape and the position of a drawn figure as the shape and the position of the capture range 350A (step S55). When determining that the selected designation mode is the second mode (second mode in step S52), the first controller 150A receives selection of an application (step S54) and sets the selected application in the capture range 350A (step S55). When determining that the selected designation mode is the third mode (third mode in step S52), the first controller 150A sets, as the capture range 350A, an entire image displayed on the display panel 125A (step S55) and shifts to step S6.

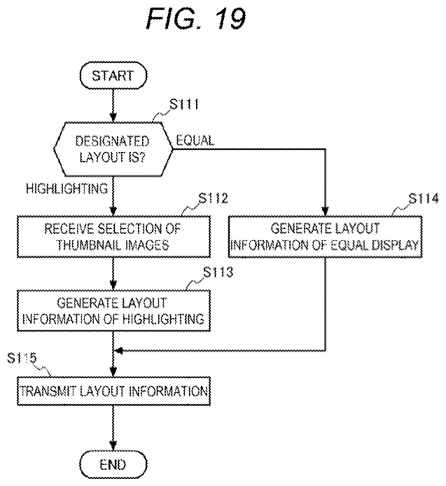

Subsequently, the processing for transmitting the layout information 263 in step S11 is explained with reference to FIG. 19. When determining that the layout operation is instructed (YES in step S10), the first controller 150A determines whether the designated layout is the highlighting or the equal display (step S111). For example, the first controller 150A determines whether the pressed layout button is the highlighting button 314A or the equal display button 315A.

When the highlighting button 314A is pressed, the first controller 150A determines that the highlighting is instructed (highlighting in step S111) and receives selection of the thumbnail image 325 to be highlighted (step S112). When receiving the selection of the thumbnail image 325 to be highlighted, the first controller 150A generates the layout information 263 of the highlighting in which the selected thumbnail image 325 is enlarged and displayed (step S113). The first controller 150A may determine, according to the number of thumbnail images 325, which layout is adopted in the highlighting. When a layout is designated in advance, the layout may foe adopted.

When the equal display button 315A is pressed (equal in step S111), the first controller 150A generates the layout information 263 of the equal display (step S114). The first controller 150A transmits the layout information 263 generated in step S113 or S114 to the host device 200 (step S115). Thereafter, the first controller 150A shifts to the determination in step S10 shown in FIG. 17.

### 7. Operation Flowchart of the Host Device

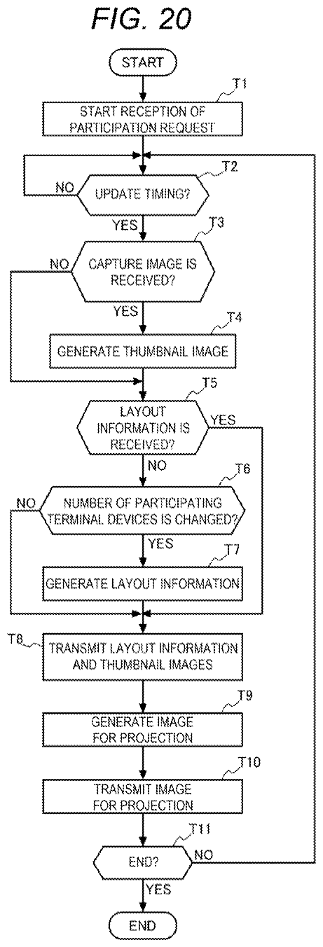

FIG. 20 is a flowchart showing the operation of the host device 200.

The operation of the host device 200 is explained with reference to the flowchart of FIG. 20.

First, when the host meeting application 261 is started, the second controller 250 starts reception of participation requests from terminal devices 100 (step T1). When receiving the participation requests from the terminal devices 100, the second controller 250 starts a session of a meeting between the host device 200 and the terminal devices 100 that transmit the participation requests. The host device 200 receives identification information from the terminal devices 100 that transmit the participation requests and causes the second storage 260 to store the identification information. The host device 200 transmits size information of the image for projection 15 to the terminal devices 100. The second controller 250 repeats the operation explained above every time a new participation request is received.

The second controller 250 determines whether it is update timing for the image for projection 15 and the thumbnail images 325 (step T2). The second controller 250 determines, based on, for example, an elapsed time from the last update time, whether it is the update timing. When determining that it is the update timing (YES in step T2), the second controller 250 shifts to step T3. When determining that it is not the update timing, the second controller 250 stays on standby until the update timing (NO in step T2).

When determining that it is the update timing (YES in step T2), the second controller 250 determines whether the capture images 55 are received from the terminal devices 100 (step T3). When determining that the capture images 55 are received from none of the terminal devices 100, the identification information of which is stored, (NO in step T3), the second controller 250 shifts to step T5.

When determining that the capture images 55 are received from one or more of the terminal devices 100, the identification information of which is stored, (YES in step T3), the second controller 250 reduces the received capture images 55 and generates the thumbnail images 325 (step T4). The second storage 260 stores the received capture images 55 and the generated thumbnail images 325 in association with the identification information of the terminal devices 100 that transmit the capture images 55.

Subsequently, the second controller 250 determines whether the layout information 263 is received from any one of the terminal devices 100 (step T5). When determining that the layout information 263 is received (YES in step T5), the second controller 250 updates the layout information 263 of the second storage 260 to the received layout information 263 and shifts to step T8.

When not: receiving the layout information 263 (NO in step T5), subsequently, the second controller 250 determines whether the number of terminal devices 100 participating in the meeting is changed (step T6). The second controller 250 determines, based on, for example, whether the number of kinds of identification information stored in the second storage 260 coincides with the number of kinds of identification information included in the layout information 263 currently referred to, whether the number of terminal devices 100 is changed. When the number of the kinds of identification information coincides, the second controller 250 determines that the number of terminal devices 100 is not changed (NO in step T6) and shifts to step S10.

When the identification information does not coincide, the second controller 250 determines that the number of terminal devices 100 is changed (YES in step T6) and generates new layout information 263 (step T7). The second controller 250 determines a new layout based on the latest number of kinds of identification information stored in the second storage 260. For example, when the immediately preceding layout is the equal display and when the immediately preceding layout information 263 is absent, the second controller 250 may generate the layout information 263 of the equal display. When the immediately preceding layout is the highlighting, the second controller 250 may generate the layout information 263 of the highlighting for enlarging a selected thumbnail image 325. Since the number of terminal devices 100 is changed, the second controller 250 may generate the layout information 263 of the equal display corresponding to the number of kinds of identification information irrespective of the immediately preceding layout. The second controller 250 causes the second storage 260 to store the generated layout information 263.

Subsequently, the second controller 250 transmits the latest layout information 263 and the latest thumbnail images 325 stored in the second storage 260 to the terminal devices 100 (step T8). When the layout information 263 is received from the terminal devices 100 (YES in step T5), the received layout information 263 is transmitted. When the second controller 250 generates new layout information 263 (step T7), the layout information 263 generated by the second controller 250 is transmitted.

Subsequently, the second controller 250 develops the capture images 55 according to the latest layout information 263 stored in the second storage 260 and generates the image for projection 15 (step T9) . The second controller 250 transmits the generated image for projection 15 to the projector 50 and causes the projector 50 to display the image for projection 15 (step T10).

Thereafter, the second controller 250 determines whether an end of the meeting is instructed (step T11). For example, the second controller 250 determines, based on whether operation for instructing an end of the meeting or the application to the host meeting application 261 is received, whether the end of the meeting is instructed. When the operation for instructing the end of the application is not received, the second controller 250 determines that the end of the meeting is not instructed (NO in step T11), returns to step T2, and repeats the series of processing. When receiving the operation for instructing the end of the application is received, the second controller 250 determines that the end of the meeting is instructed (YES in step T11), ends the communication with the terminal devices 100 and the projector 50, and ends the processing flow.

### 8. Overview

The terminal device 100A receives operation for selecting a designation mode used by the terminal device 100A among a plurality of modes for designating a range of an image and outputs the capture image 55A, which is an image in the capture range 350A designated by the received designation mode, among images generated by the terminal device 100A. The terminal device 100B receives operation for selecting a designation mode used by the terminal device 100B among the plurality of designation modes and outputs the capture image 55B, which is an image in a second range designated by the received designation mode, among images generated by the terminal device 100B. The projector 50 displays an image in which the capture image 55A and the capture image 55B are arranged side by side.

Accordingly, by respectively selecting the designation mode of the terminal device 100A and the designation mode of the terminal device 100B, it is possible to cause the projector 50 to display the image for projection 15 in which the capture image 55A and the capture image 55B respectively corresponding to the capture rage 350A and the capture range 350B designated by the designation modes selected by the terminal devices 100A and 100B are arranged side by side.

Therefore, the terminal device 100A and the terminal device 100B can respectively select ranges of images that terminal device 100A and the terminal device 100B cause the projector 50 to display. Therefore, it is possible to increase a degree of freedom or selection of images to be projected and improve convenience of the user.

The terminal device 100A includes the display panel 125A. The plurality of designation modes include the frame selection mode and the free selection mode. When the frame selection mode or the free selection mode is selected as the designation mode, the terminal device 100A receives designation of a shape of the capture range 350A and a position of the capture range 350A in the display panel 125A.

The terminal device 100A outputs, as the capture image 55A, an image displayed in the capture range 350A having a shape in the position of the display panel 125A to output the capture image 55A.

Therefore, since the user can output an image on the display panel 125 to the display device as the capture image 55 in a desired position and a desired shape, it is possible to increase a degree of freedom of image selection and improve convenience of the user.

The plurality of designation modes include the application selection mode. When the application selection mode is selected as the designation mode, the terminal device 100A receives operation for selecting an application.

The terminal device 100A outputs, as the capture image 55A, the application image 360A generated by the application to output the capture image 55A.

Therefore, the application image 360A generated by the selected application can be output as the capture image 55A. It is possible to improve convenience of the user.

When the designation mode is the frame selection mode or the free selection mode and a part of the application image 360A generated by the application is included in the capture range 350A, the terminal device 100A outputs the capture image 55A including a part of the application image 360A to output the capture image 55A.

Therefore, since an image including a part of the application image 360A generated by the application as an image included in the capture range 350A designated on the display panel 125 can be output as the capture image 55A, it is possible to improve convenience of the user.

The terminal device 100C outputs the capture image 55C. The terminal device 100A receives operation for designating a layout of an image.

The projector 50 displays an image in which the capture image 55A, the capture image 55B, and the capture image 55C are arranged side by side in the layout.

The operation for designating the layout includes operation for selecting an image to be enlarged and displayed in the image from the capture image 55A, the capture image 55B, and the capture image 55C.

Therefore, the image to be enlarged and displayed can be selected from the capture image 55A, the capture image 55B, and the capture image 55C included in the image for projection 15. It is possible to improve convenience of the user.

When displaying the image, the projector 50 displays, when the image to be enlarged and displayed is the capture image 55A, an image including the enlarged capture image 55A, the capture image 55B arranged laterally to the enlarged capture image 55A, and the capture image 55C arranged longitudinally to the enlarged capture image 55A.

Therefore, when the image for projection 15 including the capture images 55A, 55B, and 55C, the capture image 55A being enlarged and displayed, is displayed on the projection surface 10, the image for projection 15 can be displayed in a suitable layout.

The terminal device 100D outputs the capture image 55D.

When displaying the image, the projector 50 displays an image including the enlarged capture image 55A, the capture image 55B arranged laterally to the enlarged capture image 55A, the capture image 55C arranged longitudinally to the enlarged capture image 55A, and the capture image 55D arranged on the opposite side of the capture image 55B with respect to the enlarged capture image 55A.

The terminal device 100D outputs the capture image 55D.

When displaying the image, the projector 50 displays, on one screen, an image including the enlarged capture image 55A, the capture image 55B arranged laterally to the enlarged capture image 55A, the capture image 55C arranged longitudinally to the enlarged capture image 55A, and the capture image 55D arranged on the same side of the capture image 55B with respect to the enlarged capture image 55A.

Therefore, when the image for projection 15 including the capture images 55A, 55B, 55C, and 55D, the capture image 55A being enlarged and displayed, is displayed on the projection surface 10, the image for projection 15 can be displayed in a suitable layout.

The display system 1 in this embodiment includes the terminal device 100A, the terminal device 100B, and the projector 50.

The terminal device 100A includes the first processor 170A that receives operation for selecting a designation mode used by the terminal device 100A among a plurality of designation modes for designating a range of an image and outputs the capture image 55A, which is an image in the capture range 350A designated by the selected designation mode, among images generated by the terminal device 100A.

The terminal device 100B includes a first processor 170B that receives operation for selecting a designation mode used by the terminal device 100B among the plurality of designation modes and outputs the capture image 55B, which is an image in the capture range 350B designated by the selected designation mode, among images generated by the terminal device 100B.

The projector 50 includes an optical device that displays an image in which the capture image 55A and the capture image 55B are arranged side by side.

Accordingly, by respectively selecting a designation mode of the terminal device 100A and a designation mode of the terminal device 100B, it is possible to cause the projector 50 to display the image for projection 15 in which the capture image 55A and the capture image 55B respectively corresponding to the capture range 350A and the capture range 350B designated by the designation modes selected by the terminal devices 100A and 100B are arranged side by side.

Therefore, since the terminal device 100A and the terminal device 100B can respectively select ranges of images that terminal device 100A and the terminal device 100B cause the projector 50 to display. Therefore, it is possible to increase a degree of freedom of selection of an image to be projected and improve convenience of the user.

The embodiment explained above is a preferred embodiment of the present disclosure. However, the present disclosure is not limited to the embodiment explained above and various modified implementations are possible within a range not departing from the gist of the present disclosure.

For example, in the embodiment explained above, the example is explained in which the host device 200 transmits the layout information 263 and the thumbnail images 325 to the terminal device 100. In order to reduce an amount of data transmitted from the host device 20G to the terminal device 100, the host device 200 may foe configured to transmit only the layout information 263 to the terminal device 100. In this case, the terminal device 100 does not display the thumbnail images 325. When receiving the layout information 263, the terminal device 100 displays, in a position designated by the layout information of the image display region 320, an image of a frame indicating a display region of the capture images 55.

In the embodiment explained above, the terminal device 100 executes the client meeting application 165A and the host device 200 executes the host meeting application 261. The client meeting application 165A and the host meeting application 261 may be respectively different kinds or software as in the example explained above. However, the functions of both of the applications may be implemented in independent software. In that case, the terminal device 100 and the host device 200 execute the same meeting application to realize the functions of the terminal device 100 and the host device 200.

In the embodiment explained above, the application image 300 and the image for projection 15 are generated using the capture images 55 transmitted from the terminal device 100 and are displayed. When an application executed by the host device 200 includes the function of the client meeting application 165A, the host device 200 may function as both of the host device 200 and the terminal device 100. That is, the host device 200 may display the application image 300 and the image tor projection 15 including the capture images 55 of the host device 200.

In the embodiment explained above, the plurality of terminal devices 100 participate in the meeting. However, the number of devices that generate the capture images 55 only has to be one or more. For example, only the capture images 55A of the terminal device 100A may be used. When an application executed by the host device 200 includes the function of the client meeting application 165A, only the capture images 55 generated by the host device 200 may be used.

In the embodiment explained above, the system and the application for holding a meeting are explained as an example. However, a use of the display system is not limited to the system for a meeting. The display system and the display control method in the embodiment can be suitably used for any use for displaying the image for projection 15 in which the capture images 55 transmitted from the plurality of terminal devices 100 are arranged side by side.

A part of functions realized by software in the embodiment may be realized by hardware. A part of functions realized by hardware in the embodiment may be realized by software. Besides, specific detailed configurations of the other sections of the projector 50 can also be optionally changed in a range not departing from the gist of the present disclosure. The same applies to the host device 200 shown in FIG. 3.

The flowcharts showing the processing of the terminal device 100 in FIGS. 17 to 19 are divided according to main processing contents in order to make it easy to understand the processing of the first controller 150A. The present disclosure is not limited by the method of division and the names of the processing units shown in FIGS. 17 to 20. The processing of the first controller 150A can also be divided into a larger number of processing units according to the processing contents or can also be integrated such that one processing unit includes a larger number of kinds of processing. The processing order of the flowcharts is not limited to the illustrated example. The same applies to the flowchart showing the processing of the second controller 250 in FIG. 20.

When the display control method is realized using computers included in the terminal device 100 and the host device 200, programs to be executed by the computers can also be configured in a form of a recording medium or a transmission medium for transmitting the programs. As the recording medium, a magnetic or optical recording medium or a semiconductor memory device can be used. The recording medium may be a nonvolatile storage device such as a RAM, a ROM, or an HDD, which is an internal storage device included in a server device.

What is claimed is:

1. A display control method comprising:
receiving, by a first terminal device, operation for selecting a first terminal mode, which is a mode used by the first terminal device, among a plurality of modes for designating a range of an image;
outputting, by the first terminal device, a first image, which is an image in a first range, designated by the first terminal mode among images generated by the first terminal device;
receiving, by a second terminal device, operation for selecting a second terminal mode, which is a mode used by the second terminal device, among the plurality of modes;
outputting, by the second terminal device, a second image, which is an image in a second range, designated by the second terminal mode among images generated by the second terminal device; and
displaying, by a display device, a layout image in which the first image and the second image are arranged side by side.

2. The display control method according to claim 1, wherein
the first terminal device includes a first screen,
the plurality of modes include a first mode,
the display control method further comprises, when the first terminal mode is the first mode, receiving, by the first, terminal device, designation of a shape of the first range and a position of the first range on the first screen, and
the outputting the first image includes outputting, as the first image, an image displayed in the first range having the shape in the position of the first screen.

3. The display control method according to claim 1, wherein
the plurality of modes include a second mode,
the display control method further comprises, when the first terminal mode is the second mode, receiving, by the first terminal device, operation for selecting an application program, and
the outputting the first image includes outputting, as the first image, an application image generated by the application program.

4. The display control method according to claim 2, wherein, when the first terminal mode is the first mode and a part of an application image generated by an application program is included in the first range, the outputting the first image includes outputting the first image including the part of the application image.

5. The display control method according to claim 1, further comprising:
outputting a third image by a third terminal device; and
receiving, by the first terminal device, operation for designating a layout of the layout image, wherein
the displaying the layout image includes displaying the layout image in which the first image, the second image, and the third image are arranged side by side in the layout, and
the operation for designating the layout includes operation for selecting an image to be enlarged in the layout image from the first image, the second image, and the third image.

6. The display control method according to claim 5, wherein, when the image to be enlarged is the first image, the displaying the layout image includes displaying the layout image including an enlarged first image, the second image arranged laterally to the enlarged first image, and the third image arranged longitudinally to the enlarged first image.

7. The display control method according to claim 6, further comprising outputting a fourth image by a fourth terminal device, wherein
the displaying the layout image includes displaying the layout image including the enlarged first image, the second image arranged laterally to the enlarged first image, the third image arranged longitudinally to the enlarged first image, and the fourth image arranged on an opposite side of the second image with respect to the enlarged first image.

8. The display control method according to claim 6, further comprising outputting a fourth image by a fourth terminal device, wherein
the displaying the layout image includes displaying the image including the enlarged first image, the second image arranged laterally to the enlarged first image, the third image arranged longitudinally to the enlarged first image, and the fourth image arranged on a same side of the second image with respect to the enlarged first image.

9. A display system comprising:
a first terminal device including at least one first processor that executes
receiving operation for selecting a first terminal mode, which is a mode used by the first terminal device, among a plurality of modes for designating a range of an image, and
outputting a first image, which is an image in a first range, designated by the first terminal mode among images generated by the first terminal device;
a second terminal device including at least one second processor that executes
receiving operation for selecting a second terminal mode, which is a mode used by the second terminal device, among the plurality of modes, and
outputting a second image, which is an image in a second range, designated by the second terminal mode among images generated by the second terminal device; and
a display device that displays an image in which the first image and the second image are arranged side by side.
